(19) United States
(12) Patent Application Publication
(10) Pub. No.: US 2026/0272259 A1
(43) Pub. Date: Sep. 17, 2026

(54) PUMP ASSEMBLY FOR A DISHWASHER APPLIANCE

(71) Applicant: Haier US Appliance Solutions, Inc., Wilmington, DE (US)

(72) Inventors: Kyle Edward Durham, Simpsonville, KY (US); Aleksei Shaverin, Benton, KY (US)

(21) Appl. No.: 19/080,519

(22) Filed: Mar. 14, 2025

(51) Int. Cl. A47L 15/42; A47L 15/22; F16D 41/18

(52) U.S. Cl. CPC A47L 15/4225; A47L 15/22; F16D 41/18

(57) ABSTRACT

A fluid circulation assembly comprising a drive shaft defining an axial direction, a radial direction, and a circumferential direction, a motor operable to rotate the drive shaft in a first direction and in a second direction opposite the first direction, a pump impeller positioned on the drive shaft, and a clutch assembly mechanically coupling the pump impeller to the drive shaft. The clutch assembly includes a clutch housing defining a central cavity and a plurality of protrusions extending inward along the radial direction into the central cavity and a clutch rotatably mounted within the central cavity of the clutch housing, the clutch comprising a plurality of resilient arms that engage the plurality of protrusions and rotate the clutch housing when the drive shaft rotates in the first direction.

### FIELD OF THE INVENTION

The present disclosure relates generally to dishwasher appliances, and more particularly to an improved pump assembly for dishwasher appliances.

### BACKGROUND OF THE INVENTION

Dishwasher appliances generally include a tub that defines a wash chamber. Rack assemblies can be mounted within the wash chamber of the tub for receipt of articles for washing. Wash fluid (e.g., various combinations of water and detergent along with optional additives) may be introduced into the tub where it collects in a sump space at the bottom of the wash chamber. During wash and rinse cycles, a pump may be used to circulate wash fluid to spray assemblies within the wash chamber that can apply or direct wash fluid towards articles disposed within the rack assemblies in order to clean such articles. During a drain cycle, a pump may periodically discharge soiled wash fluid that collects in the sump space and the process may be repeated.

Conventional dishwasher appliances use two separate motors to operate a wash pump and a drain pump. However, additional motors take up more space, add cost, and require additional seals, thus increasing the likelihood of leaks and decreasing appliance reliability. Certain dishwasher appliances have eliminated the need for a second motor by using a single motor and a common drive shaft to rotate a wash pump impeller and a drain pump impeller. In this regard, the wash pump impeller and the drain pump impeller may be separated by a filter, and the motor may rotate in one direction to circulate wash fluid (i.e., the “wash direction”) and the other to drain wash fluid (i.e., the “drain direction”).

However, because impellers have the tendency to pump fluid even when rotated in the reverse direction (albeit less efficiently), the drain pump impeller may discharge water from the sump even when the motor is rotating in the wash direction. Certain dishwasher appliances have attempted to prevent this issue using complicated valve systems or one-way clutches, but these solutions may be expensive and/or increase the load on the motor.

Accordingly, a dishwasher appliance that utilizes a single motor and common drive shaft to rotate a wash pump and a drain pump would be useful. More specifically, a drain pump assembly that does not pump fluid when the common drive shaft is rotated in the wash direction would be particularly beneficial.

### BRIEF DESCRIPTION OF THE INVENTION

Advantages of the invention will be set forth in part in the following description, or may be apparent from the description, or may be learned through practice of the invention.

In one exemplary embodiment, a fluid circulation assembly is provided including a drive shaft defining an axial direction, a radial direction, and a circumferential direction, a motor operable to rotate the drive shaft in a first direction and in a second direction opposite the first direction, a pump impeller positioned on the drive shaft, and a clutch assembly mechanically coupling the pump impeller to the drive shaft. The clutch assembly includes a clutch housing defining a central cavity and a plurality of protrusions extending inward along the radial direction into the central cavity and a clutch rotatably mounted within the central cavity of the clutch housing, the clutch comprising a plurality of resilient arms that engage the plurality of protrusions and rotate the clutch housing when the drive shaft rotates in the first direction.

In another exemplary embodiment, a dishwasher appliance is provided including a wash tub that defines a wash chamber, a wash rack mounted within the wash chamber, the wash rack being configured for receiving articles for washing and a fluid circulation assembly for providing a flow of wash fluid for cleaning articles placed within the wash chamber. The fluid circulation assembly includes a drive shaft defining an axial direction, a radial direction, and a circumferential direction, a motor operable to rotate the drive shaft in a first direction and in a second direction opposite the first direction, a pump impeller positioned on the drive shaft, and a clutch assembly mechanically coupling the pump impeller to the drive shaft, the clutch assembly comprising: a clutch housing defining a central cavity and a plurality of protrusions extending inward along the radial direction into the central cavity; and a clutch rotatably mounted within the central cavity of the clutch housing, the clutch comprising a plurality of resilient arms that engage the plurality of protrusions and rotate the clutch housing when the drive shaft rotates in the first direction.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of an exemplary embodiment of a dishwashing appliance of the present disclosure with a door in a partially open position.

FIG. 2 provides a side, cross-sectional view of the exemplary dishwashing appliance of FIG. 1.

FIG. 3 provides a perspective view of certain components of a fluid circulation assembly according to an example embodiment of the present subject matter.

FIG. 4 provides a perspective, cross-sectional view of the exemplary fluid circulation assembly of FIG. 3 according to an example embodiment of the present subject matter.

FIG. 5 provides a side, cross-sectional view of the exemplary fluid circulation assembly of FIG. 3 according to an example embodiment of the present subject matter.

FIG. 6 provides a perspective view of a drain pump impeller that may be used with the example fluid circulation assembly of FIG. 3, according to an example embodiment of the present subject matter.

FIG. 7 provides an exploded view of the example drain pump impeller of FIG. 6 according to an example embodiment of the present subject matter.

FIG. 8 provides a cross-sectional view of the example drain pump impeller of FIG. 6 according to an example embodiment of the present subject matter.

FIG. 9 provides a partial top view of the example drain pump impeller of FIG. 6 according to an example embodiment of the present subject matter.

FIG. 10 provides a perspective view of a wash pump impeller that may be used with the example fluid circulation assembly of FIG. 3, according to an example embodiment of the present subject matter.

FIG. 11 provides a partial top view of the example wash pump impeller of FIG. 10 according to an example embodiment of the present subject matter.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As explained herein, aspects of the present subject matter are generally directed to a clutch mechanism which works through the elastic deformation of clutch arms to engage a wash or drain impeller. Further, a selection of impeller activity such as drain impeller or circulation impeller is dependent on the ability of motor to rotate both clockwise and counterclockwise direction. In this regard, when the motor shaft rotates clockwise, the clutch arms engage with protrusions, driving the drain impeller. Conversely, when the shaft rotates counterclockwise, the clutch arms deform inward, allowing them to slide over the protrusions without engaging, which minimizes friction and prevents significant fluid movement.

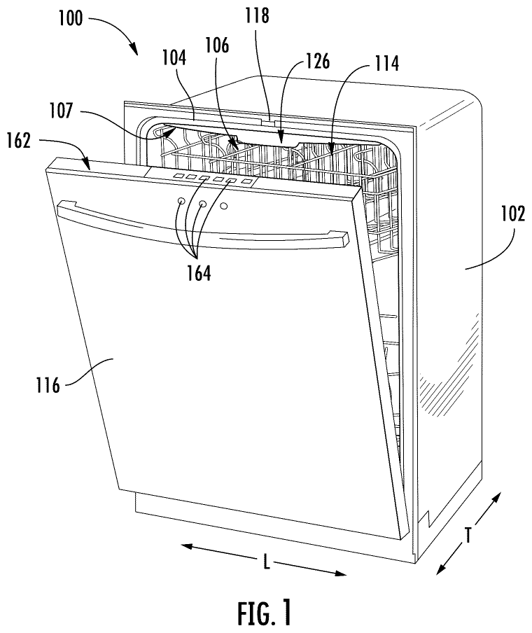

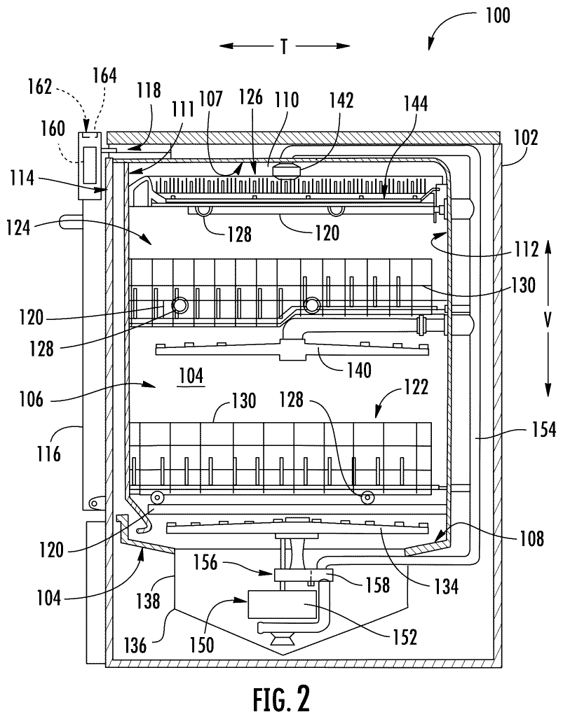

FIGS. 1 and 2 depict an exemplary domestic dishwasher or dishwashing appliance 100 that may be configured in accordance with aspects of the present disclosure. For the particular embodiment of FIGS. 1 and 2, the dishwasher 100 includes a cabinet 102 (FIG. 2) having a tub 104 therein that defines a wash chamber 106. As shown in FIG. 2, tub 104 extends between a top 107 and a bottom 108 along a vertical direction V, between a pair of side walls 110 along a lateral direction L, and between a front side 111 and a rear side 112 along a transverse direction T. Each of the vertical direction V, lateral direction L, and transverse direction T are mutually perpendicular to one another.

The tub 104 includes a front opening 114 and a door 116 hinged at its bottom for movement between a normally closed vertical position (shown in FIG. 2), wherein the wash chamber 106 is sealed shut for washing operation, and a horizontal open position for loading and unloading of articles from the dishwasher 100. According to exemplary embodiments, dishwasher 100 further includes a door closure mechanism or assembly 118 that is used to lock and unlock door 116 for accessing and sealing wash chamber 106.

As best illustrated in FIG. 2, tub side walls 110 accommodate a plurality of rack assemblies. More specifically, guide rails 120 may be mounted to side walls 110 for supporting a lower rack assembly 122, a middle rack assembly 124, and an upper rack assembly 126. As illustrated, upper rack assembly 126 is positioned at a top portion of wash chamber 106 above middle rack assembly 124, which is positioned above lower rack assembly 122 along the vertical direction V. Each rack assembly 122, 124, 126 is adapted for movement between an extended loading position (not shown) in which the rack is substantially positioned outside the wash chamber 106, and a retracted position (shown in FIGS. 1 and 2) in which the rack is located inside the wash chamber 106. This is facilitated, for example, by rollers 128 mounted onto rack assemblies 122, 124, 126, respectively. Although a guide rails 120 and rollers 128 are illustrated herein as facilitating movement of the respective rack assemblies 122, 124, 126, it should be appreciated that any suitable sliding mechanism or member may be used according to alternative embodiments.

Some or all of the rack assemblies 122, 124, 126 are fabricated into lattice structures including a plurality of wires or elongated members 130 (for clarity of illustration, not all elongated members making up rack assemblies 122, 124, 126 are shown in FIG. 2). In this regard, rack assemblies 122, 124, 126 are generally configured for supporting articles within wash chamber 106 while allowing a flow of wash fluid to reach and impinge on those articles, e.g., during a cleaning or rinsing cycle. According to another exemplary embodiment, a silverware basket (not shown) may be removably attached to a rack assembly, e.g., lower rack assembly 122, for placement of silverware, utensils, and the like, that are otherwise too small to be accommodated by rack 122.

Dishwasher 100 further includes a plurality of spray assemblies for urging a flow of water or wash fluid onto the articles placed within wash chamber 106. More specifically, as illustrated in FIG. 2, dishwasher 100 includes a lower spray arm assembly 134 disposed in a lower region of wash chamber 106. Specifically, dishwasher 100 may include a sump housing 136 that is positioned at a bottom of tub 104, the sump housing 136 defining a sump space (referred to herein generally as a sump 138). According to example embodiments, lower spray arm assembly 134 is positioned in the lower region of wash chamber 106, e.g., just above sump 138, to rotate in relatively close proximity to lower rack assembly 122.

Similarly, a mid-level spray arm assembly 140 is located in an upper region of wash chamber 106 and may be located below and in close proximity to middle rack assembly 124. In this regard, mid-level spray arm assembly 140 may generally be configured for urging a flow of wash fluid up through middle rack assembly 124 and upper rack assembly 126. Additionally, an upper spray assembly 142 may be located above upper rack assembly 126 along the vertical direction V. In this manner, upper spray assembly 142 may be configured for urging and/or cascading a flow of wash fluid downward over rack assemblies 122, 124, and 126. As further illustrated in FIG. 2, upper rack assembly 126 may further define an integral spray manifold 144, which is generally configured for urging a flow of wash fluid substantially upward along the vertical direction V through upper rack assembly 126.

The various spray assemblies and manifolds described herein may be part of a fluid distribution system or fluid circulation assembly 150 for circulating water and wash fluid in the tub 104. More specifically, fluid circulation assembly 150 includes a pump 152 for circulating water and wash fluid (e.g., detergent, water, and/or rinse aid) in the tub 104. Pump 152 may be located within sump 138 or within a machinery compartment located below sump 138 of tub 104, as generally recognized in the art. Fluid circulation assembly 150 may include one or more fluid conduits or circulation piping for directing water and/or wash fluid from pump 152 to the various spray assemblies and manifolds. For example, as illustrated in FIG. 2, a primary supply conduit 154 may extend from pump 152, along rear 112 of tub 104 along the vertical direction V to supply wash fluid throughout wash chamber 106.

As illustrated, primary supply conduit 154 is used to supply wash fluid to one or more spray assemblies, e.g., to mid-level spray arm assembly 140 and upper spray assembly 142. However, it should be appreciated that according to alternative embodiments, any other suitable plumbing configuration may be used to supply wash fluid throughout the various spray manifolds and assemblies described herein. For example, according to another exemplary embodiment, primary supply conduit 154 could be used to provide wash fluid to mid-level spray arm assembly 140 and a dedicated secondary supply conduit (not shown) could be utilized to provide wash fluid to upper spray assembly 142. Other plumbing configurations may be used for providing wash fluid to the various spray devices and manifolds at any location within dishwasher appliance 100.

Each spray arm assembly 134, 140, 142, integral spray manifold 144, or other spray device may include an arrangement of discharge ports or orifices for directing wash fluid received from pump 152 onto dishes or other articles located in wash chamber 106. The arrangement of the discharge ports, also referred to as jets, apertures, or orifices, may provide a rotational force by virtue of wash fluid flowing through the discharge ports. Alternatively, spray arm assemblies 134, 140, 142 may be motor-driven, or may operate using any other suitable drive mechanism. Spray manifolds and assemblies may also be stationary. The resultant movement of the spray arm assemblies 134, 140, 142 and the spray from fixed manifolds provides coverage of dishes and other dishwasher contents with a washing spray. Other configurations of spray assemblies may be used as well. For example, dishwasher 100 may have additional spray assemblies for cleaning silverware, for scouring casserole dishes, for spraying pots and pans, for cleaning bottles, etc. One skilled in the art will appreciate that the embodiments discussed herein are used for the purpose of explanation only, and are not limitations of the present subject matter.

In operation, pump 152 draws wash fluid in from sump 138 and pumps it to a diverter assembly 156, e.g., which is positioned within sump 138 of dishwasher appliance. Diverter assembly 156 may include a diverter disk (not shown) disposed within a diverter chamber 158 for selectively distributing the wash fluid to the spray arm assemblies 134, 140, 142 and/or other spray manifolds or devices. For example, the diverter disk may have a plurality of apertures that are configured to align with one or more outlet ports (not shown) at the top of diverter chamber 158. In this manner, the diverter disk may be selectively rotated to provide wash fluid to the desired spray device.

According to an exemplary embodiment, diverter assembly 156 is configured for selectively distributing the flow of wash fluid from pump 152 to various fluid supply conduits, only some of which are illustrated in FIG. 2 for clarity. More specifically, diverter assembly 156 may include four outlet ports (not shown) for supplying wash fluid to a first conduit for rotating lower spray arm assembly 134, a second conduit for rotating mid-level spray arm assembly 140, a third conduit for spraying upper spray assembly 142, and a fourth conduit for supplying a filter cleaning assembly or other subsystem, which will be described in more detail below according to an exemplary embodiment.

The dishwasher 100 is further equipped with a controller 160 to regulate operation of the dishwasher 100. The controller 160 may include one or more memory devices and one or more microprocessors, such as general or special purpose microprocessors operable to execute programming instructions or micro-control code associated with a cleaning cycle. The memory may represent random access memory such as DRAM, or read only memory such as ROM or FLASH. In one embodiment, the processor executes programming instructions stored in memory. The memory may be a separate component from the processor or may be included onboard within the processor. Alternatively, controller 160 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

The controller 160 may be positioned in a variety of locations throughout dishwasher 100. In the illustrated embodiment, the controller 160 may be located within a control panel area 162 of door 116 as shown in FIGS. 1 and 2. In such an embodiment, input/output (“I/O”) signals may be routed between the control system and various operational components of dishwasher 100 along wiring harnesses that may be routed through the bottom of door 116. Typically, the controller 160 includes a user interface panel/controls 164 through which a user may select various operational features and modes and monitor progress of the dishwasher 100. In one embodiment, the user interface 164 may represent a general purpose I/O (“GPIO”) device or functional block. In one embodiment, the user interface 164 may include input components, such as one or more of a variety of electrical, mechanical or electro-mechanical input devices including rotary dials, push buttons, and touch pads. The user interface 164 may include a display component, such as a digital or analog display device designed to provide operational feedback to a user. The user interface 164 may be in communication with the controller 160 via one or more signal lines or shared communication busses.

It should be appreciated that the invention is not limited to any particular style, model, or configuration of dishwasher 100. The exemplary embodiment depicted in FIGS. 1 and 2 is for illustrative purposes only. For example, different locations may be provided for user interface 164, different configurations may be provided for rack assemblies 122, 124, 126, different spray arm assemblies 134, 140, 142 and spray manifold configurations may be used, and other differences may be applied while remaining within the scope of the present subject matter.

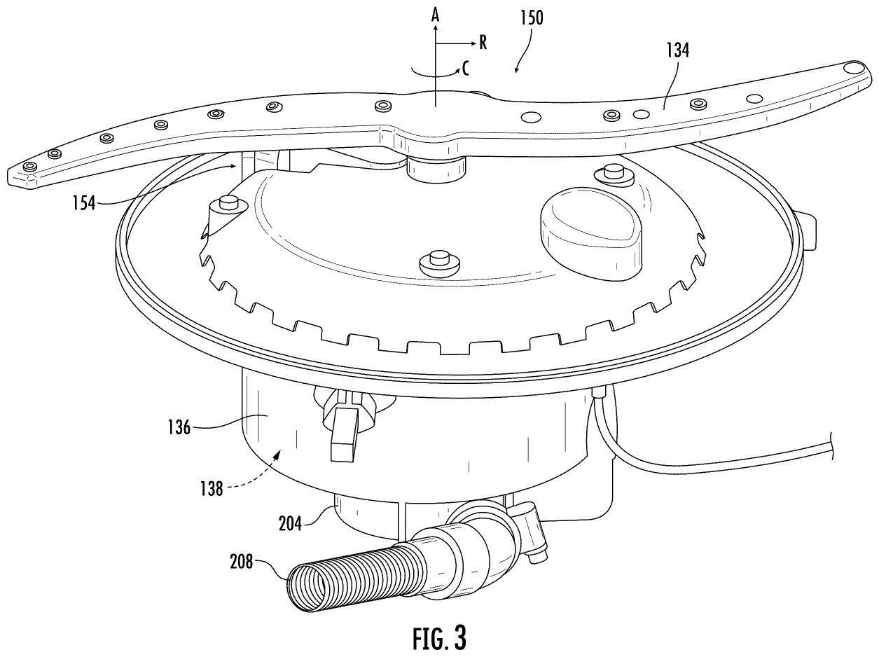

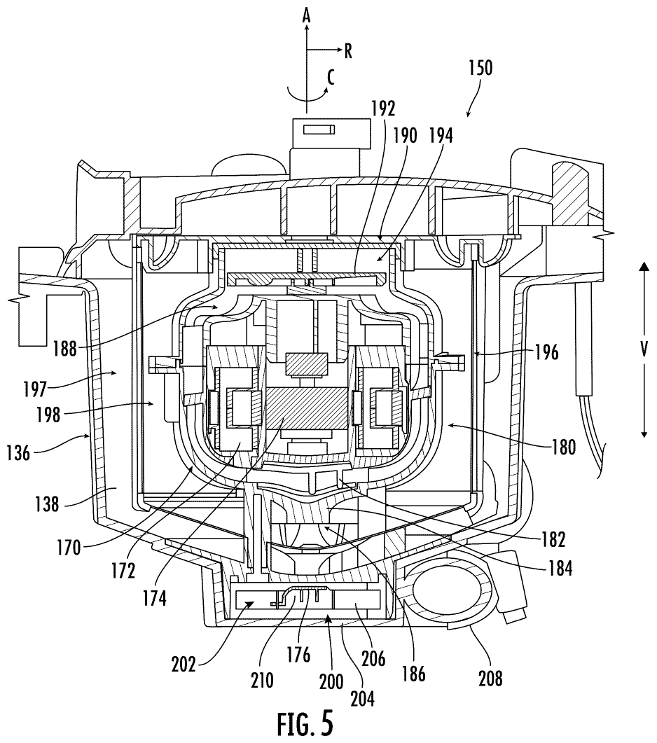

Referring now generally to FIGS. 3 through 5, fluid circulation assembly 150 will be described according to an example embodiment of the present subject matter. Fluid circulation assembly 150 may include a drive motor 170 that may be disposed within sump 138 of tub 104 and may be configured to rotate multiple components of dishwasher 100. As illustrated, drive motor 170 may be, for example, a brushless DC motor having a stator 172, a rotor 174, and a drive shaft 176 attached to rotor 174. A controller or control board (not shown) may control the speed of motor 170 and rotation of drive shaft 176 by selectively applying electric current to stator 172 to cause rotor 174 and drive shaft 176 to rotate. Although drive motor 170 is illustrated herein as a brushless DC motor, it should be appreciated that any suitable motor may be used while remaining within the scope of the present subject matter. For example, according to alternative embodiments, drive motor 170 may instead be a synchronous permanent magnet motor.

According to an example embodiment, drive motor 170 may be a variable speed motor. In this regard, drive motor 170 may be operated at various speeds depending on the current operating cycle of the dishwasher. For example, according to an exemplary embodiment, drive motor 170 may be configured to operate at any speed between a minimum speed, e.g., 1500 revolutions per minute (RPM), to a maximum rated speed, e.g., 4500 RPM. In this manner, use of a variable speed drive motor 170 enables efficient operation of dishwasher 100 in any operating mode. Thus, for example, the drain cycle may require a lower rotational speed than a wash cycle and/or rinse cycle. A variable speed drive motor 170 allows impeller rotation at the desired speeds while minimizing energy usage and unnecessary noise when drive motor 170 does not need to operate at full speed.

According to an exemplary embodiment, drive motor 170 and all its components may be potted. In this manner, drive motor 170 may be shock-resistant, submersible, and generally more reliable. Notably, because drive motor 170 is mounted inside wash chamber 106 and is completely submersible, no seals are required and the likelihood of leaks is reduced. In addition, because drive motor 170 is mounted in the normally unused space between lower spray arm assembly 134 and a bottom wall of sump 138, instead of beneath the sump 138, this design is inherently more compact than conventional designs.

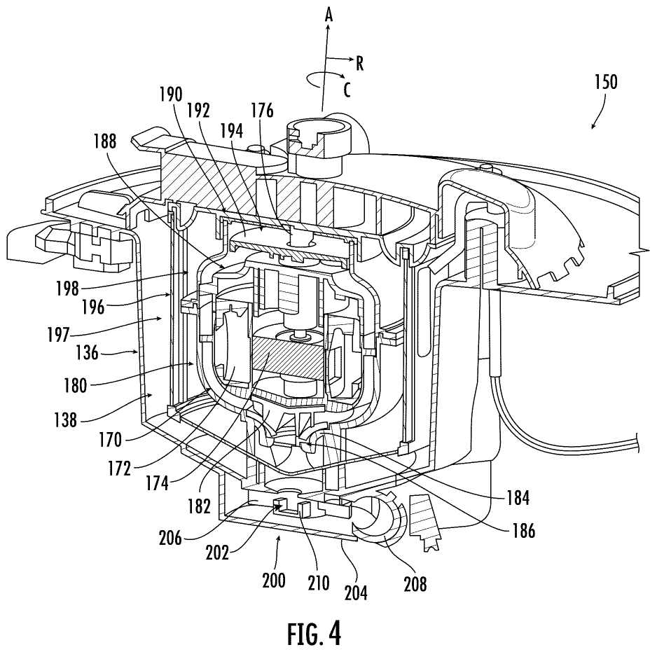

According to an exemplary embodiment, fluid circulation assembly 150 may be vertically mounted within sump 138 of wash chamber 106. More particularly, drive motor 170 of fluid circulation assembly 150 may be mounted such that drive shaft 176 is oriented along vertical direction V of dishwasher 100. More particularly, drive shaft 176 may define an axial direction A, a radial direction R, and a circumferential direction C (FIG. 3), with the axial direction A being parallel to the vertical direction V of the dishwasher 100. As illustrated in FIG. 4, drive shaft 176 is rotatably supported by upper and lower bearings and extends out of a bottom of drive motor 170 toward a bottom of sump 138. However, it should be appreciated that according to alternative embodiments, fluid circulation assembly 150 may be mounted such that drive shaft 176 is oriented in any other suitable direction, e.g., such as along a horizontal direction.

As illustrated, drive shaft 176 is configured for driving a circulation or wash pump assembly 180. Wash pump assembly 180 may generally be configured for circulating wash fluid within wash chamber 106 during wash and/or rinse cycles. More specifically, wash pump assembly 180 may include a wash pump impeller 182 disposed on drive shaft 176 within a pump housing 184. Pump housing 184 defines a pump intake 186 for drawing wash fluid into wash pump impeller 182. According to the illustrated embodiment, pump intake 186 is facing downward along the vertical direction V and is located very near the bottom of sump 138. In this manner, the amount of water required to prime and operate wash pump assembly 180 is minimized. This is particularly advantageous when running low water cycles for the purpose of water and energy savings.

As shown in FIG. 4, pump housing 184 is in fluid communication with a supply conduit 188 through which pressurized wash fluid may be recirculated through fluid circulation assembly 150. More specifically, according to the illustrated embodiment, wash pump impeller 182 draws wash fluid in from sump 138 and pumps it through supply conduit 188 to a diverter assembly 190 (such as diverter assembly 156) which generally distributes the flow of wash fluid as desired within dishwasher 100.

As shown in FIG. 4, diverter assembly 190 may include a diverter disc 192 disposed within a diverter chamber 194 (such as diverter chamber 158). Diverter chamber 194 is fluidly coupled to supply conduit 188, such that rotating diverter disc 192 may selectively distribute the flow of wash fluid to the spray arm assemblies 134, 140, 142, or any other fluid conduit coupled to diverter chamber 194. More particularly, diverter disc 192 may be rotatably mounted about the vertical direction V. Diverter disc 192 may have a plurality of apertures that are configured to align with one or more outlet ports at the top of diverter chamber 194. In this manner, diverter disc 192 may be selectively rotated to provide wash fluid to spray arm assemblies 134, 140, 142.

As illustrated, fluid circulation assembly 150 further includes a filter screen or filter 196. In general, filter 196 may define an unfiltered region 197 and a filtered region 198 within sump 138. During a wash or rinse cycle, wash fluid sprayed on dishes or other articles within wash chamber 106 falls into the unfiltered region 197. Wash fluid passes through filter 196 which removes food particles, resulting in relatively clean wash fluid within the filtered region 198. As used herein, “food particles” refers to food soil, particles, sediment, or other contaminants in the wash fluid which are not intended to travel through filter 196. Thus, a food particle seal may allow water or other wash fluids to pass from the unfiltered region 197 to the filtered region 198 while preventing food particles entrained within that wash fluid from passing along with the wash fluid.

As illustrated, filter 196 is a cylindrical and conical fine mesh filter constructed from a perforated stainless steel plate. Filter 196 may include a plurality of perforated holes, e.g., approximately 15/1000 of an inch in diameter, such that wash fluid may pass through filter 196, but food particles entrained in the wash fluid do not pass through filter 196. However, according to alternative embodiments, filter 196 may be any structure suitable for filtering food particles from wash fluid passing through filter 196. For example, filter 196 may be constructed from any suitably rigid material, may be formed into any suitable shape, and may include apertures of any suitable size for capturing particulates.

According to the illustrated exemplary embodiment, filter 196 defines an aperture through which drive shaft 176 extends. Wash pump impeller 182 is coupled to drive shaft 176 above filter 196 and a drain pump assembly (e.g., as described below) is coupled to drive shaft 176 below filter 196 along the vertical direction V. Fluid circulation assembly 150 may further include an inlet guide assembly (not labeled) which is configured for accurately locating and securing filter 196 while allowing drive shaft 176 to pass through aperture and minimizing leaks between the filtered and unfiltered regions 197, 198 of sump 138. More specifically, as best illustrated in FIG. 4, drive shaft 176 passes through a clearance bore in inlet guide assembly and through filter 196 between unfiltered region 197 and filtered region 198 of sump 138. Because the clearance bore has a diameter that is larger than the diameter of drive shaft 176, inlet guide assembly may further include a washer disposed within a chamber, e.g., in order to accommodate minor drive shaft wobble or misalignment while retaining a particle tight seal.

Referring now generally to FIGS. 3 through 5, a drain pump assembly 200 according to an exemplary embodiment of the present subject matter will be described. Drain pump assembly 200 may generally be configured for periodically discharging soiled wash fluid from dishwasher 100. Although illustrated and described as part of fluid circulation assembly 150, it should be appreciated that aspects of drain pump assembly 200 may be used in any impeller assembly in any application where it is desirable to selectively pump a fluid. In this regard, drain pump assembly 200 is only one exemplary configuration used for the purpose of explaining aspects of the present subject matter and is not intended to limit the scope of the invention in any manner.

Referring to FIG. 4, drain pump assembly 200 may include a drain pump impeller 202 that is coupled to drive shaft 176. Drain pump impeller 202 may be positioned within a drain pump volute 204 below filter 196. In this regard, drain pump volute 204 is positioned at the very bottom of sump 138, such that wash fluid collects within drain pump volute 204. Drain pump impeller 202 may include a plurality of vanes 206 extending outward along the radial direction R. During a drain cycle, drive motor 170 is rotated such that drain pump impeller 202 discharges soiled wash fluid from dishwasher 100 through a discharge conduit 208. After some or all of the soiled wash fluid is discharged, fresh water and/or wash additives may be added and the wash or rinse cycle may be repeated.

As noted above, drive motor 170 may rotate in one direction to circulate wash fluid (i.e., the “wash direction”) and the other to drain wash fluid (i.e., the “drain direction”). However, because impellers have the tendency to pump fluid even when rotated in the reverse direction (albeit less efficiently), having a wash pump impeller and a drain pump impeller on the same shaft may result in water being discharged from the sump even when the motor is rotating in the wash direction. Accordingly, aspects of the present subject matter are directed to unique clutch mechanisms that mechanically coupled one or more impellers to a drive shaft in a manner that prevents undesirable pumping by the wash pump impeller during a drain cycle and/or by the drain pump impeller during the wash cycle.

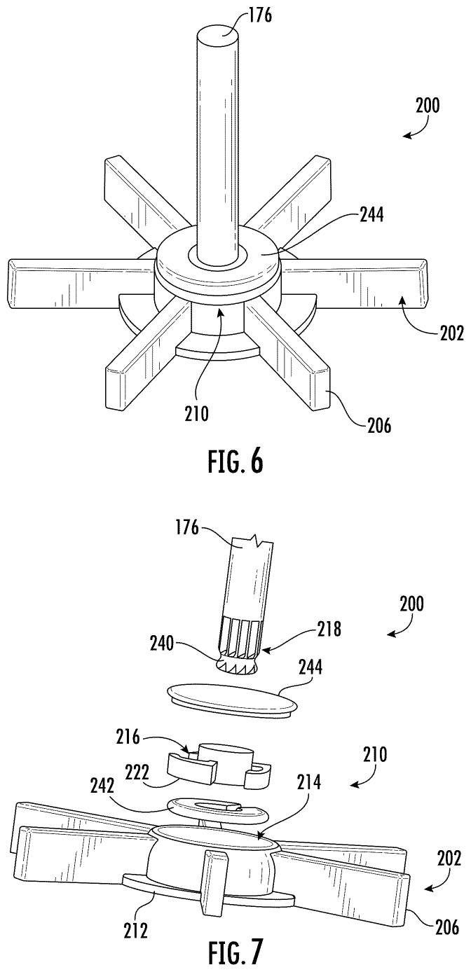

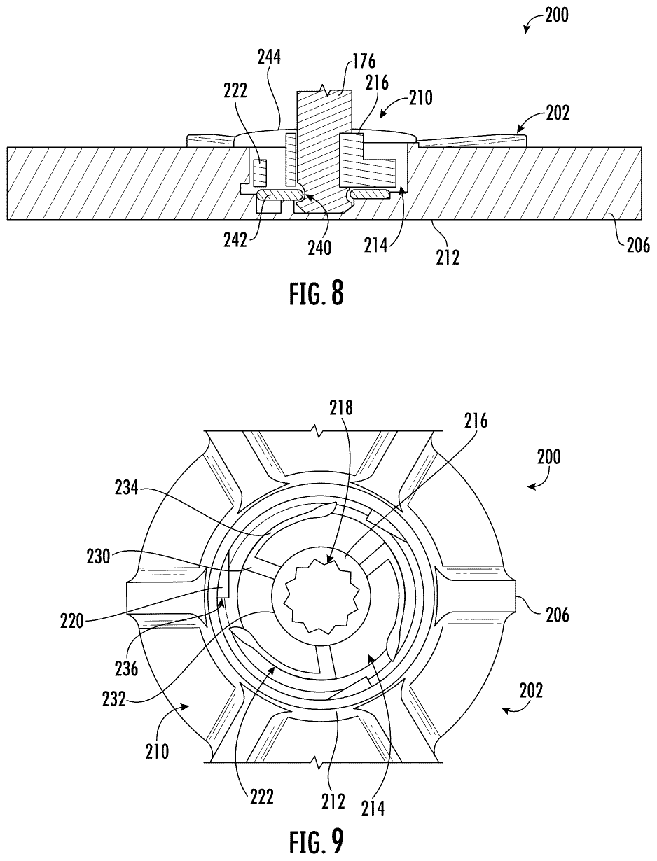

For example, referring now also to FIGS. 6 through 9, drain pump assembly 200 generally includes a clutch assembly 210 that is used to mechanically couple drain pump impeller 202 to drive shaft 176. When clutch assembly 210 is engaged, drain pump impeller 202 rotates with drive shaft 176 and vanes 206 urge wash fluid and collected soils out of dishwasher 100 through discharge conduit 208. By contrast, when clutch assembly 210 is disengaged, drain pump impeller does not rotate with drive shaft 176, such that no appreciable pressure head is developed within drain pump volute 204. An example clutch assembly 210 is described below according to an example embodiment. However, it should be appreciated that variations and modifications may be made to clutch assembly 210 while remaining within the scope of the present subject matter.

As illustrated, clutch assembly includes a clutch housing 212 generally acts as a central hub from which vanes 206 may extend within drain pump volute 204. As shown, clutch housing 212 defines a central cavity 214 that is configured to receive a clutch 216 that selectively engages or disengages clutch assembly 210. In this regard, drive shaft 176 may define a keyed structure 218 for engaging clutch 216 such that clutch 216 may rotate along with drive shaft 176 within central cavity 214. For example, keyed structure 218 is illustrated as a star-shaped or geared geometry on drive shaft 176 and a complementary geometry on clutch 216. However, it should be appreciated that any other suitable keyed structure may be used, e.g., such as a D-shaped structure, one or more locking protrusions, one or more pins, retaining clips, or other mechanical retention devices, etc.

As illustrated, clutch housing 212 may define a plurality of protrusions 220 that extend inward along the radial direction R into central cavity 214. In addition, clutch 216 may define a plurality of resilient arms 222 that engage the plurality of protrusions 220 depending on the direction of rotation of drive shaft 176. In this regard, if drive shaft 176 is rotating in a first direction, e.g., a clockwise direction, resilient arms 222 engage protrusions 220 such that clutch housing 212 and drain pump impeller 202 rotate with drive shaft 176 (i.e., clutch assembly 210 is “engaged”). By contrast, if drive shaft 176 is rotating in a second direction, e.g., a counterclockwise direction, resilient arms 222 disengage protrusions 220 such that clutch 216 rotates freely within clutch housing 212 and drain pump impeller 202 does not rotate (i.e., clutch assembly 210 is “disengaged”).

As illustrated, resilient arms 222 are designed to deflect when rotating in the second direction such that clutch 216 spins freely within clutch housing 212. According to the illustrated embodiment, each of resilient arms 222 includes a radial arm 230 that extends substantially along the radial direction R from a central hub 232 of clutch 216. In addition, a swept arm 234 extends from a distal end of radial arm 230 substantially along the circumferential direction C. In the relaxed state, an outermost radial portion of resilient arms 222 may slightly contact an innermost radial portion of protrusions 220. In this manner, when clutch 216 is rotated in the second direction, resilient arms 222 may deflect such that they do not contact protrusions 220 at all or only contact protrusions 220 slightly such that they do not impart rotational force to clutch housing 212. By contrast, when clutch is rotated in the first direction, resilient arms 222 may engage protrusions 220 and impart rotational force to clutch housing 212.

According to an example embodiment, protrusions 220 may have any suitable geometry for engaging resilient arms 222 of clutch 216. In this regard, for example, protrusions 220 may have a substantially triangular shape and have a contact wall 236 that is designed to catch a distal end of swept arm 234 and lock resilient arms 222 in place against clutch housing 212. According to the illustrated embodiment, clutch housing 212 defines an identical number of protrusions 220 as there are resilient arms 222 on clutch 216. However, it should be appreciated that the number of protrusions 220 and resilient arms 222 need not be identical. According to example embodiments, clutch 216 may define between 1 and 10 resilient arms 222, between 3 and 6 resilient arms 222, or about 5 resilient arms 222.

Clutch assembly 210 may include features to facilitate quick and easy assembly. For example, drive shaft 176 may have a circumferential groove 240 proximate a distal end of drive shaft 176 and clutch assembly 210 may include a retaining ring 242 that is seated in central cavity 214 and engages circumferential groove 240 to secure drive shaft 176. In this manner, an assembly technician may simply place retaining ring 242 in the bottom of central cavity 214 and press drive shaft 176 down to snap and lock drive shaft 176 in place. In addition, clutch assembly 210 may include a lid 244 that is positioned over the top of central cavity 214 and defines an aperture through which drive shaft 176 passes.

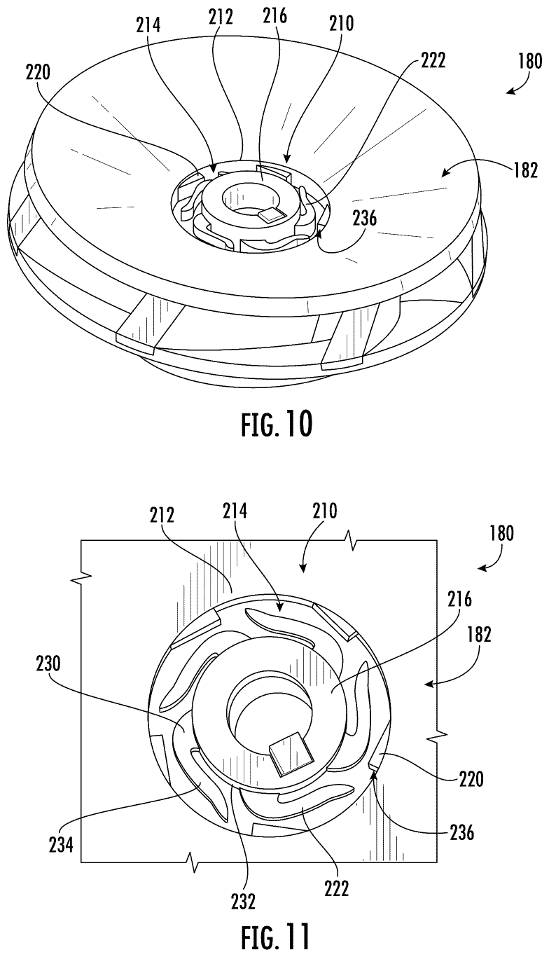

Referring now briefly to FIGS. 10 and 11, wash pump impeller 182 may be mechanically coupled to drive shaft 176 using a clutch assembly similar to that described above. Due to the similarity between these two structures, like numerals are used to refer to the same or similar features of clutch assembly 210 that is used to engage wash pump impeller 182. Indeed, the primary difference between clutch assembly 210 used to engage wash pump impeller 182 and drain pump impeller 202 is that the clutches engage in opposite directions, such that rotation of drive shaft 176 in one direction engages wash pump impeller 182 but not drain pump impeller 202, while rotation in the opposite direction engages drain pump impeller 202 but not wash pump impeller 182.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A fluid circulation assembly defining a vertical direction and comprising:
a drive shaft defining an axial direction, a radial direction, and a circumferential direction;
a motor operable to rotate the drive shaft in a first direction and in a second direction opposite the first direction;
a pump impeller positioned on the drive shaft; and
a clutch assembly mechanically coupling the pump impeller to the drive shaft, the clutch assembly comprising:
a clutch housing defining a central cavity and a plurality of protrusions extending inward along the radial direction into the central cavity; and
a clutch rotatably mounted within the central cavity of the clutch housing, the clutch comprising a plurality of resilient arms that engage the plurality of protrusions and rotate the clutch housing when the drive shaft rotates in the first direction.

2. The fluid circulation assembly of claim 1, wherein the plurality of resilient arms deflect when rotating in the second direction such that clutch spins freely within clutch housing.

3. The fluid circulation assembly of claim 1, wherein each of the plurality of protrusions is triangular.

4. The fluid circulation assembly of claim 1, wherein each of the plurality of resilient arms comprises:
a radial arm that extends substantially along the radial direction from a central hub; and
a swept arm that extends from a distal end of the radial arm substantially along the circumferential direction.

5. The fluid circulation assembly of claim 1, wherein the plurality of resilient arms comprises between 3 and 6 resilient arms.

6. The fluid circulation assembly of claim 1, wherein the drive shaft has a circumferential groove proximate a distal end of the drive shaft, and wherein the clutch assembly further comprises:
a retaining ring that is seated in the central cavity and engages the circumferential groove to secure the drive shaft.

7. The fluid circulation assembly of claim 1, wherein the drive shaft defines a keyed structure for engaging the clutch.

8. The fluid circulation assembly of claim 1, wherein the clutch assembly further comprises:
a lid positioned over the central cavity and defining an aperture through which the drive shaft passes.

9. The fluid circulation assembly of claim 1, wherein the pump impeller is a drain pump impeller.

10. The fluid circulation assembly of claim 1, wherein the pump impeller is a wash pump impeller.

11. The fluid circulation assembly of claim 1, wherein the pump impeller comprises a plurality of vanes extending outward along the radial direction from the clutch housing.

12. The fluid circulation assembly of claim 1, wherein the motor is vertically oriented within a sump area of a dishwasher, such that the drive shaft is vertically oriented relative to the dishwasher.

13. A dishwasher appliance defining a vertical, a lateral, and a transverse direction, the dishwasher appliance comprising:
a wash tub that defines a wash chamber;
a wash rack mounted within the wash chamber, the wash rack being configured for receiving articles for washing; and
a fluid circulation assembly for providing a flow of wash fluid for cleaning articles placed within the wash chamber, the fluid circulation assembly comprising:
a drive shaft defining an axial direction, a radial direction, and a circumferential direction;
a motor operable to rotate the drive shaft in a first direction and in a second direction opposite the first direction;
a pump impeller positioned on the drive shaft; and
a clutch assembly mechanically coupling the pump impeller to the drive shaft, the clutch assembly comprising: a clutch housing defining a central cavity and a plurality of protrusions extending inward along the radial direction into the central cavity; and a clutch rotatably mounted within the central cavity of the clutch housing, the clutch comprising a plurality of resilient arms that engage the plurality of protrusions and rotate the clutch housing when the drive shaft rotates in the first direction.

14. The dishwasher appliance of claim 13, wherein the plurality of resilient arms deflect when rotating in the second direction such that clutch spins freely within clutch housing.

15. The dishwasher appliance of claim 13, wherein each of the plurality of protrusions is triangular.

16. The dishwasher appliance of claim 13, wherein each of the plurality of resilient arms comprises:
a radial arm that extends substantially along the radial direction from a central hub; and
a swept arm that extends from a distal end of the radial arm substantially along the circumferential direction.

17. The dishwasher appliance of claim 13, wherein the drive shaft has a circumferential groove proximate a distal end of the drive shaft, and wherein the clutch assembly further comprises:
a retaining ring that is seated in the central cavity and engages the circumferential groove to secure the drive shaft.

18. The dishwasher appliance of claim 13, wherein the drive shaft defines a keyed structure for engaging the clutch.

19. The dishwasher appliance of claim 13, wherein the clutch assembly further comprises:
a lid positioned over the central cavity and defining an aperture through which the drive shaft passes.

20. The dishwasher appliance of claim 13, wherein the pump impeller is a drain pump impeller or a wash pump impeller.
